(19) United States
(12) Patent Application Publication
(10) Pub. No.: US 2009/0151175 A1
(43) Pub. Date: Jun. 18, 2009

(54) Adjustable Rotary Structure

(76) Inventor: Tsai-Lian Chen LIN, Huatan Township (TW)

Correspondence Address: Dr. BANGER SHIA, 102 Lindencrest Ct., Sugar Land, TX, 77479-5201, US

(21) Appl. No.: 11/957,386

(22) Filed: Dec. 14, 2007

(51) Int. Cl. B43L 11/04

(52) U.S. Cl. 33/30.4

(57) ABSTRACT

An adjustable rotary structure comprises a first restricting assembly, a second restricting assembly, a rotary member and a positioning seat. The rotary member is formed with a restricting hole and a shift hole. The positioning seat is formed with a positioning groove, a restricting circular groove and a restricting elliptic groove. The first restricting assembly is positioned on the positioning groove by the restricting hole in such a manner that the restricting hole of the rotary member abuts against the positioning groove and is restricted on the positioning seat. The second restricting assembly is selectively positioned in the restricting circular groove or the restricting elliptic groove via the shift hole, so that the rotary member is forced to rotate along a circular path or an elliptic path.

### BACKGCIRCULAR OF THE INVENTION

1. Field of the Invention

The present invention relates to a sheet material cutting structure, and more particularly to an adjustable rotary structure which can adjust a circular or an elliptic rotation path.

2. Description of the Prior Art

Referring to FIG. 1, a conventional sheet material cutting structure 10 (as shown in FIG. 1) comprises a cutting assembly 11 and a positioning assembly 12. The cutting assembly 11 includes a horizontal slideway 111 and a vertical cutting tool 112. The positioning assembly 12 includes a horizontal sliding portion 121 and a vertical inserting member 122. The sliding portion 121 of the positioning assembly 12 can be slidably assembled on the slideway 111 of the cutting assembly 11, so that the distance between the cutting tool 112 of the cutting assembly 11 and the inserting member 122 of the positioning assembly 12 can be adjusted. The user can insert the inserting member 122 of the positioning assembly 12 into the sheet material (the sheet may be a paper sheet), and then perform a rotation around the inserting member 122 to make the cutting tool 122 to cut out a circular sheet. However the conventional sheet material cutting structure 10 still has the following problems:

First, the sheet material cutting structure 10 only can cut out a circular sheet, and it cannot be directly used to cut out an elliptic sheet, so the sheet material cutting structure 10 is monotonous in function without variety, and the monotonic products relatively reduce the purchase desire of the user, thus reducing the economic benefit due to the low product demand;

Second, the inserting member 122 of the positioning assembly 12 of the sheet material cutting structure 10 only provides a single pivot, so when the circular cutting operation is performed, the inserting member 122 is quite likely to insert through the paper sheet, thus causing the inserting member 122 of the positioning assembly 12 to offset and sway. Therefore, the cutting tool 112 of the cutting assembly 11 cannot smoothly cut the sheet material into the desired shape, thus increasing the defective rate.

The present invention has arisen to mitigate and/or obviate the afore-described disadvantages.

### SUMMARY OF THE INVENTION

The primary objective of the present invention is to provide an adjustable rotary structure capable of adjusting a circular or an elliptic rotation path.

In order to achieve the above objective, the adjustable rotary structure in accordance with the present invention comprises a first restricting assembly, a second restricting assembly, a rotary member and a positioning seat. One side of the rotary member is formed with a restricting hole and a shift hole that are spaced apart by a certain distance. The positioning seat is formed with a positioning groove, a restricting circular groove and a restricting elliptic groove. Further, the positioning seat is disposed with at least two inserting members. The first restricting assembly is inserted through the restricting hole of the rotary member to be positioned on the positioning groove of the positioning seat, so that the restricting hole of the positioning seat is restricted on the positioning seat by the positioning groove. The second restricting assembly is inserted through the shift hole to be selectively positioned in the restricting circular groove or the restricting elliptic groove of the positioning seat. Based on a further analysis of the aforementioned, the present invention has the following advantages:

First, the rotary member is restricted on the positioning seat by the restricting member and then the second restricting assembly horizontally moves on the rotary member to be selectively inserted into the restricting circular groove or the restricting elliptic groove, so that the operator can arbitrarily adjust the rotary member to select the circular rotation path or the elliptic rotation path, thus providing the user with the functions: flexible to change and convenient to adjust;

Second, the user utilizes the positioning seat to contact the sheet material to be cut in a surface-to-surface manner, so as to averagely apply the press force to the positioning seat via the first restricting assembly, and then utilizes the inserting members and the anti-slip mats of the positioning seat to stably position the positioning seat on the sheet material to be cut for making the cutting operation or the line drawing operation smoother and more regular.

### BRIEF DESCRIPTION OF THE DRAWINGS

FIG. 1 is a schematic view showing how a conventional sheet material cutting structure is used;

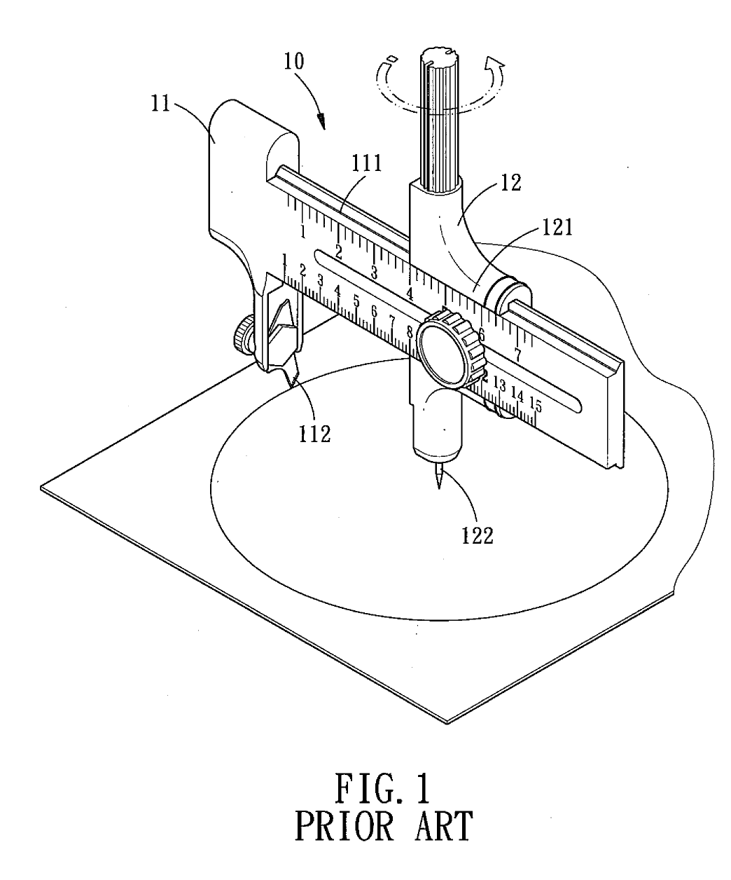

FIG. 2 is an exploded view of an adjustable rotary structure in accordance with the present invention;

FIG. 3 is a perspective view showing that the adjustable rotary structure in accordance with the present invention is used together with a blade holder and a brush holder;

FIG. 4 is a cross sectional view showing that the circle cutting operation is in a preparatory state in accordance with the present invention;

FIG. 5 is a schematic view showing the circle cutting operation in accordance with the present invention;

FIG. 6 is a cross sectional view of the ellipse cutting is in a preparatory state in accordance with the present invention; and

FIG. 7 is a schematic view showing the ellipse cutting operation is in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

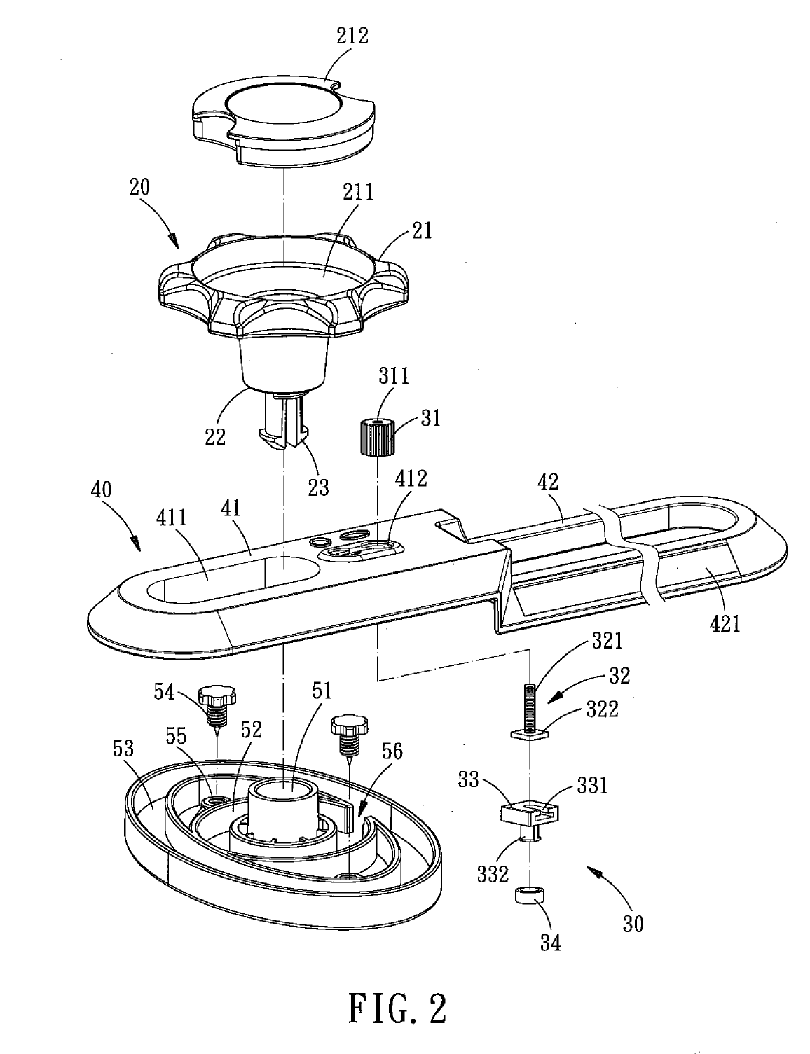

Referring to FIGS. 2-4, an adjustable rotary structure in accordance with the present invention comprises a first restricting assembly 20, a second restricting assembly 30, a rotary member 40 and a positioning seat 50.

The first restricting assembly 20 is formed at one end thereof with a disc-shaped press portion 21. The press portion 21 is formed in the top surface thereof with a concave storage groove 211 which is used to engage with a sealing cover 212 for preventing the blades from dropping out of storage groove 211 of the press portion 21. The first restricting assembly 20 is formed with a step stop surface 22 in the middle thereof, and an engaging portion 23 at the other end thereof.

The second restricting assembly 30 includes a locking member 31, a locked member 32, a slide seat 33 and a ring 34. The locking member 31 includes an internal thread hole 311. The locked member 32 includes an external thread segment 321 and a positioning protruding piece 322. The external thread segment 321 of the locked member 32 is screwed into the internal thread hole 311 of the locking member 31. The slide seat 33 is rectangular block-shaped structure and includes a restricting groove 331 for an insertion of the positioning protruding piece 322 of the locked member 32. The slide seat 33 is formed with a restricting protrusion 332 on the bottom side thereof. The ring 34 is a through hollow cylinder and is restricted on the slide seat 33 by the restricting protrusion 332.

The rotary member 40 is an integrated sheet-shaped member. There is a step segment formed by two continuous right-angled bending portions in the middle of the rotary member 40. One side of the rotary member 40 is formed with an adjustment portion 41, and the other side of the rotary member 40 is formed with an assembling portion 42. The horizontal plane of the adjustment portion 41 is higher than that of the assembling portion 42. The adjustment portion 41 is formed with a through restricting hole 411 and a shift hole 412. The restricting hole 411 and the shift hole 412 are spaced apart by a certain distance. The middle segment of the restricting hole 412 is a rectangle with two arc-shaped ends. The shift hole 412 is formed at the bottom side with a shift groove 413 in which the slide seat 33 of the second restricting assembly 30 is slidably disposed. The external thread segment 321 of the locked member 32 of the second restricting assembly 30 is inserted through the shift hole 412, and the internal thread hole 311 of the locking member 31 of the second restricting assembly 30 is screwed on the external thread segment 321 of the locked member 32. When the locked member 32 is locked to the end of the locking member 31, one end of the locked member 33 is pressed against the shift hole 413 by the slide seat 33.

The positioning seat 50 is formed on one surface thereof with a positioning groove 51, a restricting circular groove 52, a restricting elliptic groove 53 and two inserting members 54 which are concentrically and sequentially arranged from the center of the positioning seat 50. The positioning groove 51 is a circular groove, and the positioning groove 51 is higher than the positioning seat 50. The interior of the positioning groove 51 is provided for the insertion of the engaging portion 23 of the first restricting assembly 20 to press the end edge of the positioning groove 51 against the stop surface 22 of the first restricting assembly 20. The exterior of the positioning groove 51 is inserted into the restricting hole 411 of the adjustment portion 41 of the rotary member 40, so as to restrict the rotary member 40 on the periphery of the positioning groove 51. The positioning seat 50 is formed at both ends adjacent to the bottom thereof with two through holes 55. The respective through holes 55 are not in either the restricting circular groove 52 or the restricting elliptic groove 53. Each through hole 55 is provided for screwing an inserting member into. The restricting protrusion 332 of the slide seat 33 of the second restricting assembly 30 is slidably disposed in the restricting circular groove 52 or the restricting elliptic groove 53. Between the restricting circular groove 52 and the restricting elliptic groove 53 is formed a displacement gap 56 for selectively shifting the second restricting assembly 30 to the restricting circular groove 52 or the restricting elliptic groove 53. Further, the positioning seat 50 can be disposed with a plurality of anti-slip mats 57 on the bottom surface thereof.

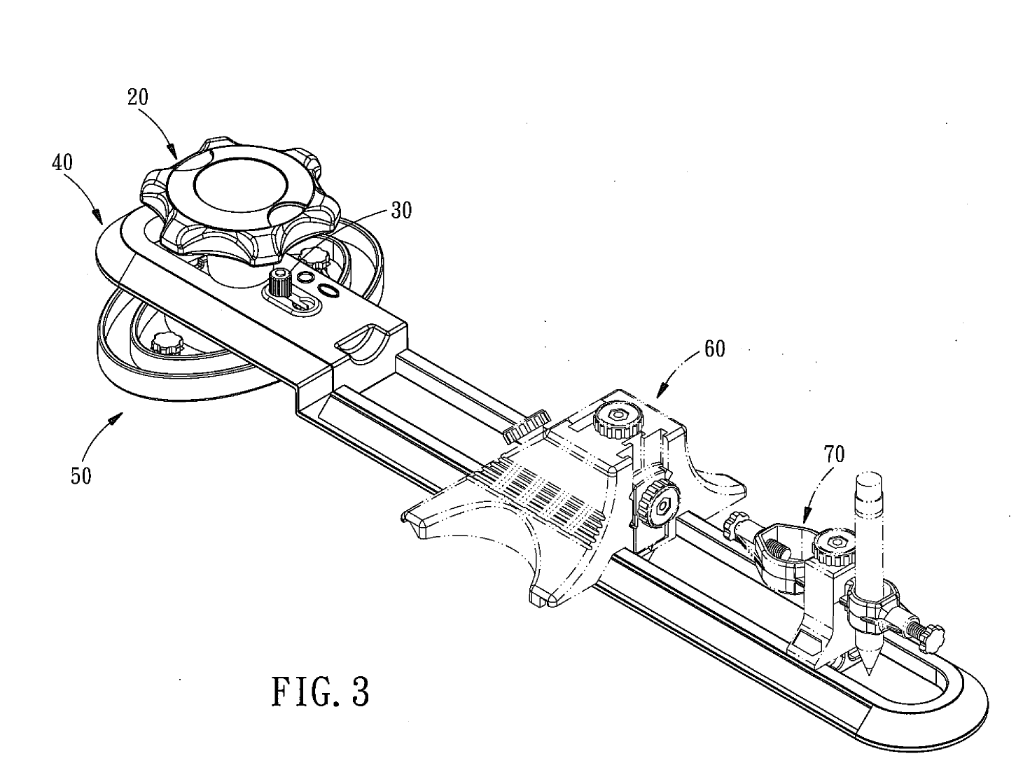

The assembling portion 42 of the rotary member 40 (as shown in FIG. 3) is disposed on one side with a marking region 421 for assembling a blade holder 60 to perform a cutting operation or for assembling a brush holder 70 to draw lines.

The aforementioned is the key technology and the summary of the positional and structural relationship of the respective components of the preferred embodiment in accordance with the present invention.

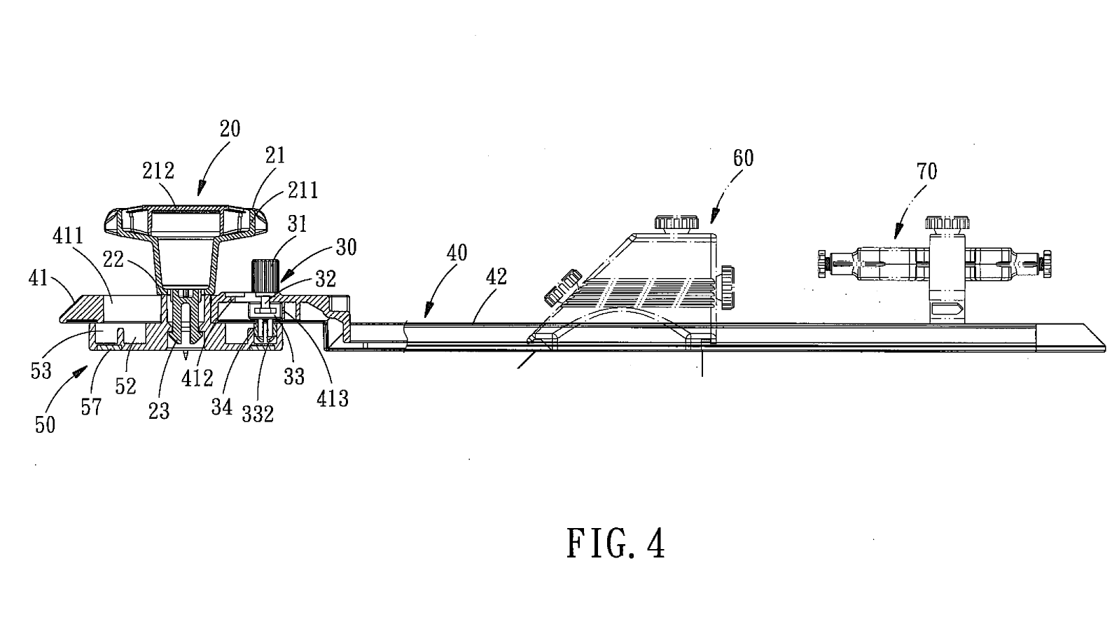

For a better understanding of the present invention, its operation and function, reference should be made to FIGS. 4-7:

When in use, firstly, the user presses the positioning seat 50 to position the inserting members 54 assembled in the two through holes 55 on the sheet material to be cut or position them on the sheet material to be cut through the anti-slip mats 57 on the bottom surface of the positioning seat 50.

Subsequently, after the shape (circular or elliptic) to be cut is selected, the locking member 31 of the second restricting assembly 30 can be unscrewed. By controlling the movement of the locking member 31 of the second restricting assembly 30, the locked member 32 is moved in the shift hole 412 of the rotary member 40, and the slide seat 33 is moved in the shift groove 412 of the rotary member 40 and the displacement gap 56 of the positioning seat 50. The second restricting assembly 30 can be moved to selectively insert into the restricting circular groove 52 of the positioning seat 50 or the restricting elliptic groove 53. The following description is based on two states: A. circle cutting operation; B. ellipse cutting operation.

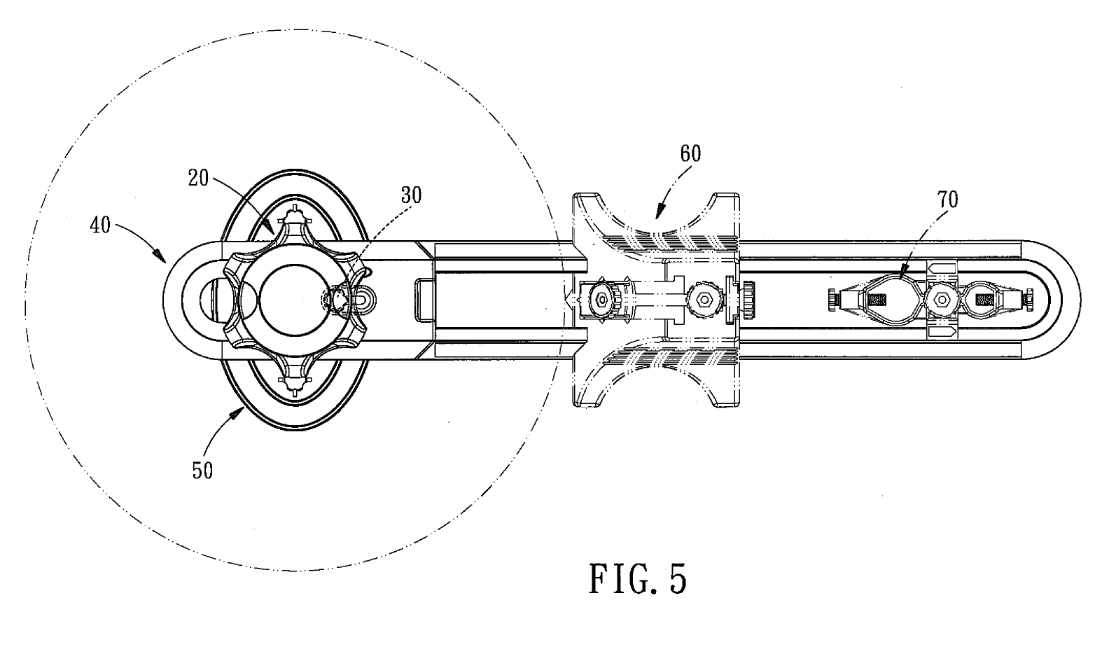

A. circle cutting operation: when the user inserts the second restricting assembly 30 into the restricting circular groove 50 of the positioning seat 50 through the shift hole 412 (please refer to FIGS. 4-5), the rotary member 40 can be rotated to enable the restricting hole 411 of the adjustment portion 41 of the rotary member 40 to abut against the periphery of the positioning groove 51 of the positioning seat 50 and rotate. At this moment, the restricting protrusion 332 of the slide seat 33 of the second restricting assembly 30 slides along the restricting circular groove 52 through the ring 34 to form a circular rotation path. At the same moment of the rotation, the rotary member 40 can utilize the blade holder 60 or the brush holder 70 of the assembling portion 42 to form or draw a circle;

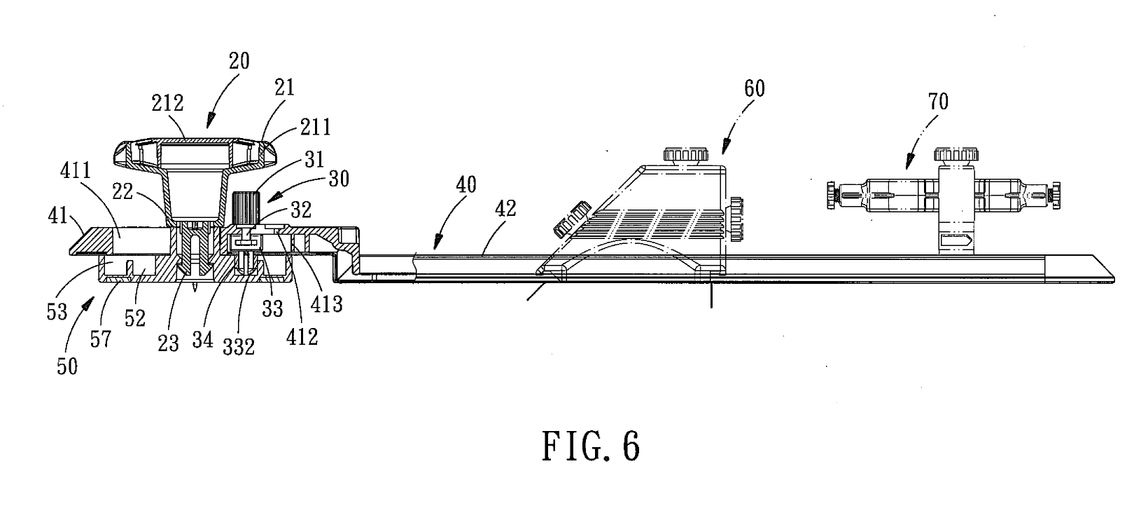

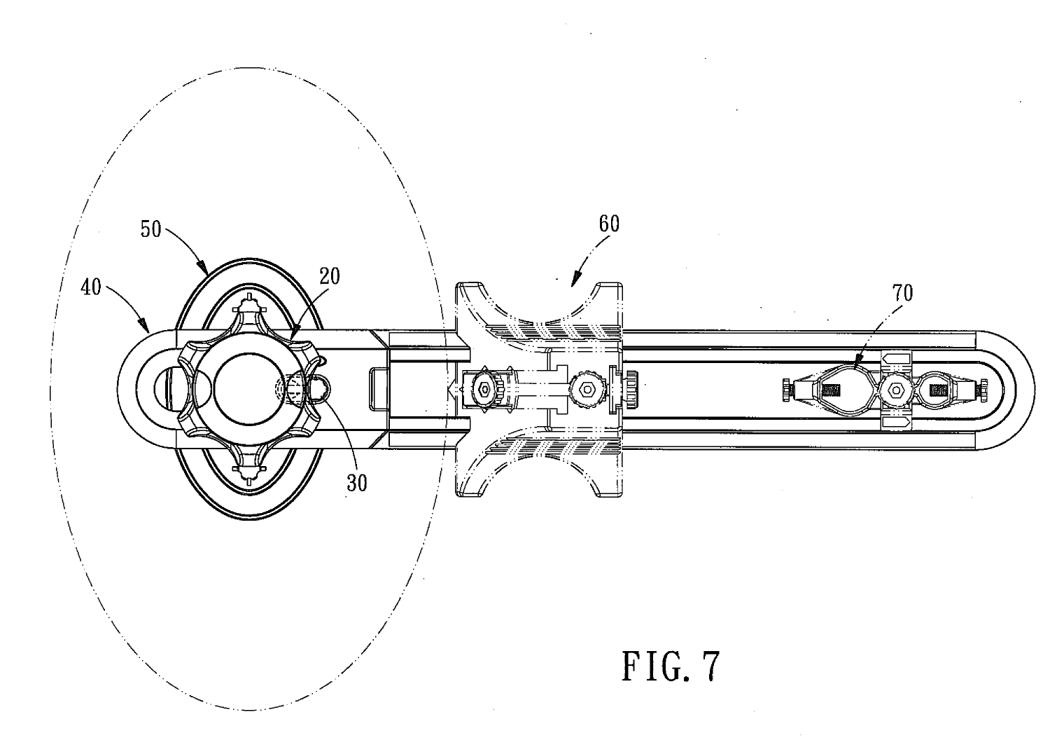

B. ellipse cutting operation: When the user inserts the second restricting assembly 30 into the restricting elliptic groove 53 of the positioning seat 50 through the shift hole 412 (please refer to FIGS. 6-7), the rotary member 40 can be rotated to enable the restricting hole 411 of the adjustment portion 41 of the rotary member 40 to abut against the periphery of the positioning groove 51 of the positioning seat 50 and rotate. At this moment, the restricting protrusion 332 of the slide seat 33 of the second restricting assembly 30 slides along the restricting elliptic groove 53 to form an elliptic path. At the same moment of the rotation, the rotary member 40 can utilize the blade holder 60 or the brush holder 70 of the assembling portion 42 to form or draw an ellipse.

The restricting hole 411 of the adjustment portion 41 of the rotary member 40 is restricted on the positioning seat 50 by the first restricting assembly 20. By inserting the second restricting assembly 30 into the restricting circular groove 52 or the restricting elliptic groove 52 through the shift hole 412 of the adjustment portion 41, when the rotary member 40 rotates, the second restricting assembly 30 is enabled to rotate along the circular path formed by the restricting circular groove 52 or the elliptic path formed by the restricting elliptic groove 53. Based on a further analysis of the above structure, the present invention has the following advantages:

First, the user can directly adjust the circular rotation path or the elliptic rotation path to change the cutting shape, so the product variety of the present invention can improve the purchase desire of the consumer and increase the product demand, thus improving the economic benefit;

Second, the user utilizes the positioning seat 50 to contact the sheet material to be cut in a surface-to-surface manner, so the longitudinal force is averagely applied through the positioning seat. Further, the positioning seat 50 will be positioned on the sheet material by using the inserting members 54 as two pivots to prevent the transverse force from causing the movement of the positioning seat 50, so that the rotary member 40 can perform a smoother cutting or line-drawing operation during the rotation, thus not only reducing the defect rate but reducing the material cost.

To summarize, the present invention provides an adjustable rotary structure comprising a first restricting assembly, a second restricting assembly, a rotary member and a positioning member. The rotary member is formed with a restricting hole and a shift hole. The positioning seat is formed with a positioning groove, a restricting circular groove and a restricting elliptic groove. The first restricting assembly is positioned on the positioning groove through the restricting hole, so that the restricting hole of the rotary member is pressed against the positioning groove and is positioned on the positioning seat. The second restricting assembly is selectively positioned in the restricting circular groove or the restricting elliptic groove through the shift hole, so as to force the rotary to rotate along the circular path or the elliptic path.

While we have shown and described various embodiments in accordance with the present invention, it is clear to those skilled in the art that further embodiments may be made without departing from the scope of the present invention.

What is claimed is:

1. An adjustable rotary structure comprising:
a first restricting assembly;
a second restricting assembly corresponding to the first restricting assembly;
a rotary member being formed with a restricting hole and a shift hole, the restricting hole and the shift hole being spaced apart by a certain distance, the first restricting assembly being inserted through the restricting hole of the rotary member, the second restricting assembly being inserted through the shift hole of the rotary member to horizontally move; and
a positioning seat being formed with a positioning groove, a restricting circular groove and a restricting groove, an end of the first restricting assembly being positioned in the positioning groove of the positioning seat in such a manner that the restricting hole of the rotary member abuts against the positioning groove and is restricted on the positioning seat, an end of the second restricting assembly being selectively positioned in the restricting circular groove or the restricting groove of the positioning seat to force the rotary member to rotate along a circular path or an elliptic path.

2. The adjustable rotary structure as claimed in claim 1, wherein:
the first restricting assembly is formed at one end thereof with a press portion, in the middle thereof with a step stop surface and at the other end thereof with an engaging portion;
the second restricting assembly includes a locking member, a locked member, a slide seat and a ring, the locking member includes an internal thread hole, the locked member includes an external thread segment and a positioning protruding piece, the external thread segment of the locked member is screwed into the internal thread hole of the locking member, the slide seat includes a restricting groove for an insertion of the positioning protruding piece, the slide seat is formed on one side thereof with a restricting protrusion, the ring is restricted on the slide seat by the restricting protrusion;
the rotary seat is formed on one side thereof with an adjustment portion, on the other side thereof with an assembling portion, the shift hole is formed on a bottom side thereof with a shift groove for the slide seat of the second restricting assembly to slide in, the external thread segment of the locked member of the second restricting assembly is inserted through the shift hole, the internal thread hole of the locking member of the second restricting assembly is locked on the external thread segment of the locked member;
an interior of the positioning groove of the positioning seat is provided for an insertion of the engaging portion of the first restricting assembly to enable the positioning groove abut against the stop surface of the first restricting assembly, an exterior of the positioning groove is inserted into the restricting hole of the adjustment portion of the rotary member to restrict the rotary member on the positioning groove of the positioning seat; and
the restricting circular groove or the restricting elliptic groove of the positioning seat is provided for the restricting protrusion of the slide seat of the second restricting assembly to slide in via the ring, between the restricting circular groove and the restricting elliptic groove is formed a displacement gap for selectively shifting the second restricting assembly to restricting circular groove or the restricting elliptic groove.

3. The adjustable rotary structure as claimed in claim 2, wherein the press portion is formed with a concave storage groove in a top surface thereof for engaging with a sealing cover.

4. The adjustable rotary structure as claimed in claim 2, wherein both ends of the positioning seat are formed with two through holes, the respective through holes are not in either the restricting circular groove or the restricting elliptic groove, each through hole is provided for screwing an inserting member into.

5. The adjustable rotary structure as claimed in claim 2, wherein a horizontal plane of the adjustment portion of the rotary member is higher than that of the assembling portion of the rotary member.

6. The adjustable rotary structure as claimed in claim 2, wherein the assembling portion of the rotary member further includes a blade holder.

7. The adjustable rotary structure as claimed in claim 2, wherein the assembling portion of the rotary member further includes a brush holder.

8. The adjustable rotary structure as claimed in claim 2, wherein the assembling portion of the rotary member further includes a brush holder and a blade holder.

9. The adjustable rotary structure as claimed in claim 1, wherein the positioning seat is disposed with anti-slip mats on a bottom surface thereof.
